(19) United States
(12) Patent Application Publication
(10) Pub. No.: US 2005/0108770 A1
(43) Pub. Date: May 19, 2005

(54) Method and system for mixing broadcast and stored media in a media exchange network

(76) Inventors: Jeyhan Karaoguz, Irvine, CA (US); James Bennett, Laguna Beach, CA (US)

Correspondence Address: MCANDREWS HELD & MALLOY, LTD, 500 WEST MADISON STREET, SUITE 3400, CHICAGO, IL, 60661, US

(21) Appl. No.: 10/675,057

(22) Filed: Sep. 30, 2003

Related U.S. Application Data
(60) Provisional application No. 60/432,472, filed on Dec. 11, 2002.
(60) Provisional application No. 60/443,894, filed on Jan. 30, 2003.
(60) Provisional application No. 60/457,179, filed on Mar. 25, 2003.
(60) Provisional application No. 60/445,925, filed on Feb. 6, 2003.

(51) Int. Cl. H04N 7/173

(52) U.S. Cl. 725/131; 709/231

(57) ABSTRACT

Aspects of the may be found in a method for providing a customized media channel and may comprise creating a channel guide for a new media channel and populating the channel guide for the new media channel with information identifying mixed media content. In this regard, the mixed media content may comprise at least one personal media content and at least one broadcast media content. The mixed media content as identified in the channel guide may be communicated over the mixed media channel. The populated channel guide may be displayed, with the information identifying the mixed media content, for example in a text format or a graphical user interface (GUI). The channel guide may be a representation of information for a mixed media channel. In any case, the method may also comprise receiving broadcast media content from at least one third (3^{rd}) party broadcaster or other media provider.

### CROSS-REFERENCE TO RELATED APPLICATIONS/INCORPORATION BY REFERENCE

This application makes reference to, claims priority to, and claims the benefit of:
U.S. Provisional Application Ser. No. 60/432,472 (Attorney Docket No. 14185US01 01001P-BP-2800) filed Dec. 11, 2002;
U.S. Provisional Application Ser. No. 60/443,894 (Attorney Docket No. 14274US01 01002P-BP-2801) filed Jan. 30, 2003;
U.S. Provisional Application Ser. No. 60/457,179 (Attorney Docket No. 14825US01 01015P-BP-2831) filed Mar. 25, 2003; and
U.S. Provisional Application Ser. No. 60/445,925 (Attorney Docket No. 14285US01 01016P-BP-2810) filed Feb. 6, 2003.

This application also makes reference to:
U.S. application Ser. No. ______ (Attorney Docket No. 14185US02 01001P-BP-2800) filed Sep. 8, 2003; and
U.S. application Ser. No. ______ (Attorney Docket No. 14274US02 01002P-BP-2801) filed Sep. 11, 2003.

All of the above stated applications are incorporated herein by reference in their entirety.

### FIELD OF THE INVENTION

Certain embodiments of the invention relate to channel customization. More specifically, certain embodiments of the invention relate to a method and system for mixing broadcast and stored media in a media exchange network.

### BACKGROUND OF THE INVENTION

Today, a commercial broadcast channel may be viewed on a TV (television) set in real-time when the commercial broadcast channel is actually being transmitted by a third (3^{rd}) party commercial broadcaster. Also, a user of a television and a VCR may record a commercial broadcast on video tape and view the commercial broadcast at a time subsequent to the time of transmission of the commercial broadcast.

A user of a personal media capture device may capture personal media and playback the captured media at a later time on a TV set. For example, a user of a digital camcorder may record a personal event, such as a child's sporting event, and playback the recorded event at a later time on a television.

Various types of digital media such as digital images, digital video, and digital audio may be captured and stored on a PC (personal computer) and played back on, for example, a video and/or audio player such as a television or the monitor and/or speakers of the PC. For example, a user of a digital camera may take a series of vacation pictures while on a trip to Alaska and then download the digital pictures to a personal computer or handheld for viewing.

Often, in busy households for example, family members compete, sometimes unknowingly, for use of personal computer or television use. For example, the parents may desire to share, via a television for example, vacation pictures with the neighbors at the same time that the kids desire to watch their favorite TV show or a DVD they rented. This becomes a problem particularly when the parents are unaware of the kids desire to watch the show/DVD and the kids are likewise unaware of the parents plans with the neighbors. Similarly, a family member may invite relatives over to view video of a child's participation in a sporting event, for example, and then realize only later that the agreed upon time conflicts with a professional sporting event or education program, for example, that the family member desires to watch or have others in the family watch this type of competition for television and personal computer consumption often causes tension within the family and may present uncomfortable situations for guests.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Certain embodiments of the invention may be found in a method and system for providing a customized media channel. Aspects of the method for providing a customized media channel may comprise creating a channel guide for a new media channel and populating the channel guide for the new media channel with information identifying mixed media content. A media channel is a channel that supports communication of media. The mixed media content may comprise at least one personal media content and at least one broadcast media content that may be communicated via a mixed media channel. The information identifying the mixed media content may be displayed within the populated channel guide, for example, in a text format or a graphical user interface (GUI). In any case, the method may also comprise receiving at least one broadcast media content from at least one third (3^{rd}) party broadcaster.

The received broadcast media content may be stored and the stored broadcast media content linked to a portion of the information utilized to identify the mixed media content. At least a portion of the personal media content may be identified and/or stored. In another aspect of the invention, the identified and/or stored personal media content may be associated or otherwise linked to a portion of the information utilized to identify the mixed media content and which corresponds to the personal media content. The method may also comprise scheduling the personal media content and the broadcast media content within the created channel guide for presentation or playback. In this regard, at least a date and a time may be assigned within the created channel guide for presentation or playback of the personal media content and the broadcast media content in the customized mixed media channel.

Another embodiment of the invention may provide a machine-readable storage, having stored thereon, a computer program having at least one code section for providing a customized media channel. The at least one code section may be executable by a machine, thereby causing the machine to perform the steps as described above for providing a customized media channel.

Aspects of the system for providing a customized media channel may comprise at least one processor that creates a channel guide for a new media channel and populates the channel guide for the new media channel with information identifying mixed media content. The mixed media content may comprise at least one personal media content and at least one broadcast media content that may be communicated by via a mixed media channel. The processor may be at least one of a media processing system processor, a media management system processor, a computer processor, media exchange software platform processor and a media peripheral processor. Notwithstanding, the processor may cause information identifying the mixed media content to be displayed within the populated channel guide, for example, in a text format or a graphical user interface (GUI). In any case, the processor may also be adapted to receive the broadcast media content from at least one third (3^{rd}) party broadcaster.

The processor may store the received broadcast media content and link the stored broadcast media content to a portion of the information utilized to identify the mixed media content. At least a portion of the personal media content may be identified and/or stored by the processor. In another aspect of the invention, the identified and/or stored personal media content may be associated or otherwise linked by the processor to a portion of the information utilized to identify the mixed media content and which corresponds to the personal media content. The processor may also be adapted to schedule the personal media content and the broadcast media content within the created channel guide for presentation or playback. In this regard, the processor may assign at least a date and a time within the created channel guide for presentation or playback of the personal media content and the broadcast media content.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of a media exchange network that may be utilized to support program production in accordance with an embodiment of the invention.

FIG. 1B is a diagram illustrating an embodiment of a channel view or channel guide supporting a mixed broadcast and personal media channel in a media exchange network, in accordance with various aspects of the present invention.

FIG. 1C is a diagram illustrating an updated channel view or channel guide that is an update to the channel view or channel guide of FIG. 1A and comprises a mixed broadcast and personal media channel, in accordance with various aspects of the present invention.

FIG. 2A is a flowchart illustrating an embodiment of a method that may be utilized to store broadcast and personal media in the mixed channel of the updated channel view of FIG. 1B, in accordance with various aspects of the present invention.

FIG. 2B is a diagram illustrating several sources of media program content available to the channel view of FIG. 1A in a media processing system of the media exchange network of FIG. 1A, in accordance with various aspects of the present invention.

FIG. 3 is a schematic block diagram of a first exemplary media exchange network in accordance with an embodiment of the present invention.

FIG. 4 is a schematic block diagram of performing personal media exchange over a second exemplary media exchange network in accordance with an embodiment of the present invention.

FIG. 5 is a schematic block diagram of performing third-party media exchange over a third exemplary media exchange network in accordance with an embodiment of the present invention.

FIG. 6 is an exemplary illustration of a TV guide channel user interface in accordance with an embodiment of the present invention.

FIG. 7 is an exemplary illustration of several instantiations of a TV guide channel user interface of FIG. 4 in accordance with an embodiment of the present invention.

FIG. 8 is an exemplary illustration of a TV guide channel user interface showing several options of a pushed media in accordance with an embodiment of the present invention.

FIG. 9A is a schematic block diagram of a media processing system (MPS) interfacing to media capture peripherals in accordance with an embodiment of the present invention.

FIG. 9B illustrates an alternative embodiment of a media processing system (MPS) in accordance with various aspects of the present invention.

FIG. 10 is a schematic block diagram of a PC and an MPS interfacing to a server on a media exchange network in accordance with an embodiment of the present invention.

FIG. 11 is a schematic block diagram of a PC interfacing to personal media capture devices and remote media storage on a media exchange network in accordance with an embodiment of the present invention.

### DETAILED DESCRIPTION OF THE INVENTION

Certain embodiments of the present invention relate to storing media in a customized channel. In particular, certain embodiments of the present invention relate to storing media in a customized television channel comprising both commercial broadcast programs and personal media content programs in a media exchange network. Certain embodiments of the invention may also be found in a method and system for providing a customized mixed media channel.

Aspects of the method for providing a customized media channel may comprise creating a channel view for a new media channel and populating the channel view for the new media channel with information identifying mixed media content. In this regard, the mixed media content may comprise at least one personal media content and at least one broadcast media content that may be communicated via a mixed media channel. The information identifying the mixed media content may be displayed within the populated channel view, for example, in a text format or a graphical user interface (GUI). The channel view may be a representation of information for a mixed media channel. In any case, the method may also comprise receiving at least one broadcast media content from at least one third (3^{rd}) party broadcaster.

The received broadcast media content may be stored and the stored broadcast media content linked to a portion of the information utilized to identify the mixed media content. At least a portion of the personal media content may be identified and/or stored in a storage device or storage media, for example. The identified and/or stored personal media content may be associated or otherwise linked to a portion of the information utilized to identify the mixed media content that corresponds to the personal media content. The method may also comprise scheduling the personal media content and the broadcast media content within the created channel view for presentation and/or playback in a mixed media channel. In this regard, at least a date and a time may be assigned within the created channel view for presentation or playback of the personal media content and the broadcast media content.

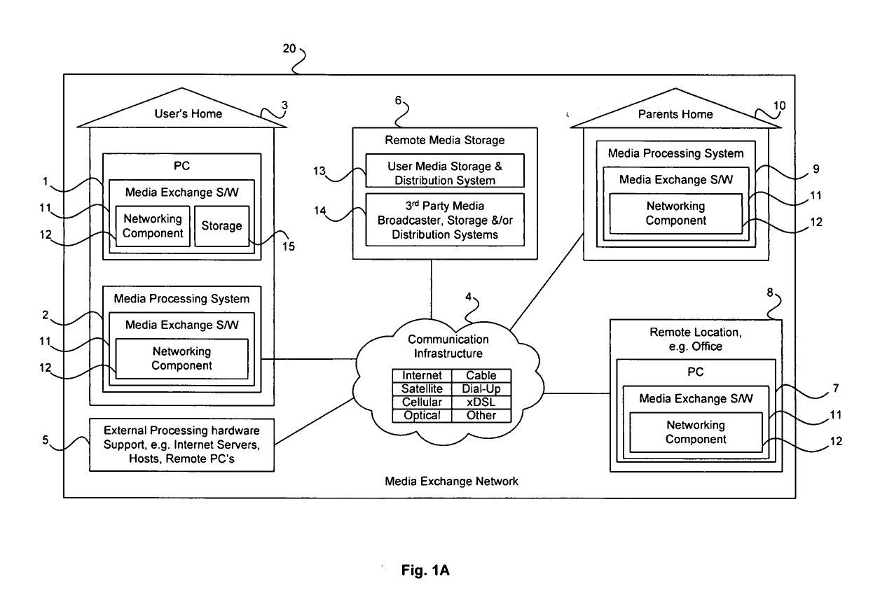

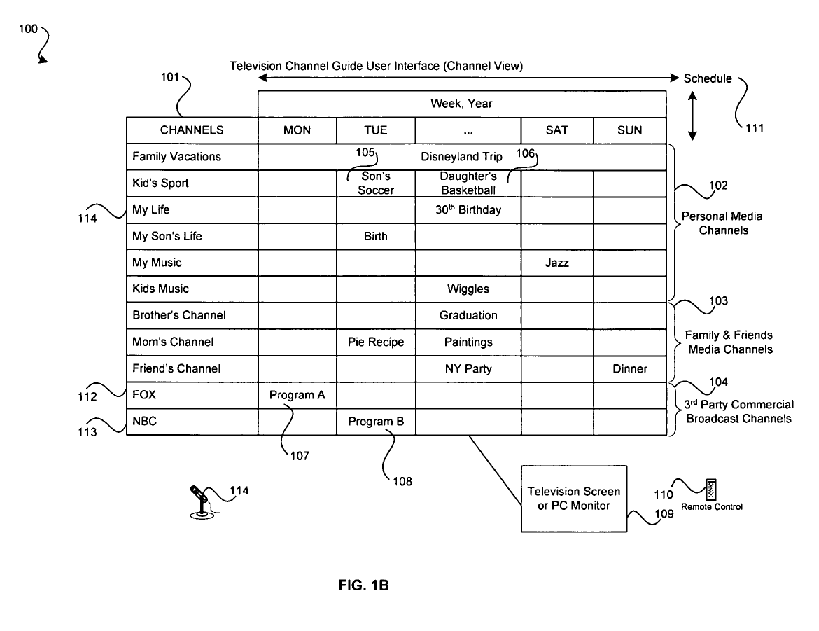

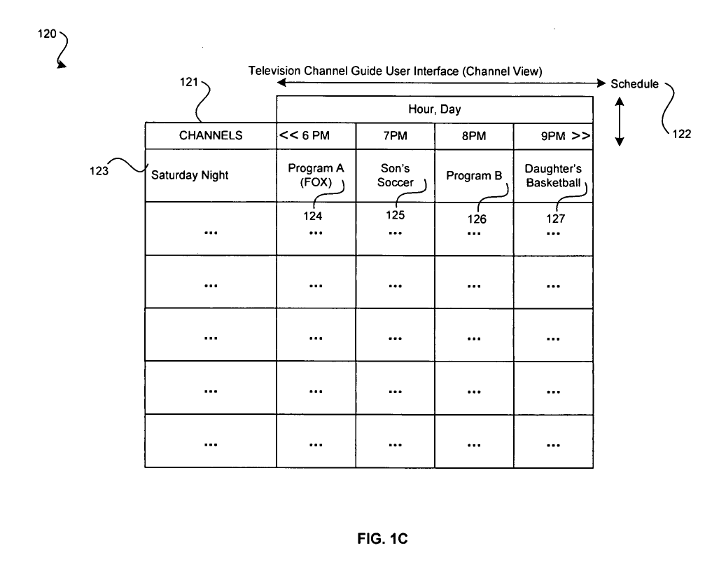

FIG. 1A is a block diagram of a media exchange network 20 that may be utilized to support program production in accordance with an embodiment of the invention. Referring to FIG. 1A, the media exchange network (MEN) of FIG. 1A may comprise a first PC 1 and a first media processing system (MPS) 2, which may be situated at a first location such as a user's home 3. The media exchange network 20 may also comprise a communication infrastructure 4, external processing hardware support 5 and remote media storage 6. A second PC 7 may be situated at a second location, which may be a remote location 8 such as an office. A third location such as a Parent's home 10 may comprise a media processing system 9. The media exchange network 20 may be a secure, closed network environment that may only be accessible to pre-defined users or subscribers and/or service providers. Notwithstanding, the invention may not be limited in this regard, and at least a portion of the network and/or services provided by the network may be publicly accessible.

The PC's in the media exchange network 20 may each comprise media exchange software and a networking component. In this regard, the personal computer 1 may comprise media exchange software 11, storage 15 and a networking component 12. The personal computer 7 may also comprise media exchange software 11 and a networking component 12. The media processing systems in the media exchange network 20 may each comprise media exchange software and a networking component. In this regard, the media processing system 2 may comprise media exchange software 11 and a networking component 12. Similarly, the media processing system 9 may comprise media exchange software 11 and a networking component 12. The networking components 12 of personal computers 1 and 7 and media processing systems 2 and 9 may be configured to provide networking connectivity to the communication infrastructure 4.

A media processing system may also comprise a set-top-box (STB), a PC, and/or a television with a media management system (MMS). A media management system may also be referred to as a media exchange software (MES) platform. Notwithstanding, a media management system may include a software platform operating on at least one processor that may provide certain functionality including user interface functionality, distributed storage functionality, networking functionality, and automatic control and monitoring of media peripheral devices. For example, a media management system may provide automatic control of media peripheral devices, automatic status monitoring of media peripheral devices, and inter-home media processing system routing selection. A media processing system may also be referred to as a media-box and/or an M-box. Any personal computer may indirectly access and/or control any media peripheral device in instances where the personal computer may include a media management system. Such access and/or control may be accomplished through various communication pathways via the media processing system or outside of the media processing system. A media processing system may also have the capability to automatically access and control any media peripheral device without user interaction and/or with user intervention. A personal computer (PC) may include media exchange software running on or being executed by the personal computer and may be referred to as a media processing system. The media processing system may also include a speech recognition engine that may be adapted to receive input speech and utilize the input speech control various functions of the media processing system.

Each of the elements or components of the network for communicating media or media exchange network may be identified by a network protocol address or other identifier which may include, but is not limited to, an Internet protocol (IP) address, a media access control (MAC) address and an electronic serial number (ESN). Examples of elements or components that may be identified by such addresses or identifiers may include media processing systems, media management systems, personal computers, media or content providers, media exchange software platforms and media peripherals.

The media exchange software platform 11 may provide functions and capabilities, which may comprise, but are not limited to media “push” capability, media “access” capability, media channel construction/selection, image sequence selection, text and voice overlay, channel and program naming and inter-home routing selection. The media exchange platform 11 may also provide authorship and media rights management, shared inter-home or inter-location media experience, billing services, and integrated television channel guide look-and-feel functionalities.

The external processing hardware support server 5 may comprise at least one server such as a centralized Internet server, a media exchange server, a peer-to-peer server, or a cable headend. Notwithstanding, functions provided by the server may alternatively be distributed over various hosts or remote PC's. The media exchange software platform 11 may also reside on the external processing hardware support server 5. The remote media storage 6 may comprise user media storage and distribution systems 13 and/or third party media broadcaster, storage and distribution systems 14.

The communication infrastructure 4 may comprise at least one of Internet infrastructure, satellite infrastructure, cable infrastructure, dial-up infrastructure, cellular infrastructure, xDSL infrastructure, optical infrastructure, or some other access and/or transport infrastructure. The communication infrastructure 4 may provide a common access and/or transport communication path for the first location or user's home 3, the second location or remote office location 8, the third location or parent's home 10 and the remote media storage 6. In this regard, the communication infrastructure 4 may provide an access and/or transport communication path that may link users and service providers of the media exchange network 20.

In accordance with various embodiments of the invention, a media processing system may also include a set-top-box (STB), a PC, and/or a television with a media management system (MMS). A media management system may also be referred to as a media exchange software (MES) platform. Notwithstanding, a media management system may include a software platform operating on at least one processor that may provide certain functionality including user interface functionality, distributed storage functionality, networking functionality, and automatic control and monitoring of media peripheral devices. For example, a media management system may provide automatic control of media peripheral devices, automatic status monitoring of media peripheral devices, and inter-home media processing system routing selection. A media processing system may also be referred to as a media-box and/or an M-box. Any of the personal computers may indirectly access and/or control any media peripheral device in instances where the personal computer may include a media management system. Such access and/or control may be accomplished through various communication pathways via the MPS or outside of the media processing system. A media processing system may also have the capability to automatically access and control any media peripheral device without user interaction and/or with user interaction. A personal computer (PC) may include media exchange software running on or being executed by the personal computer and may be referred to as a media processing system. The media processing system may also include a speech recognition engine that may be adapted to receive input speech and utilize the input speech control various functions of the media processing system. Each of the elements or components of the network for communicating media or media exchange network may be identified by a network protocol address or other identifier which may include, but is not limited to, an Internet protocol (IP) address, a media access control (MAC) address and an electronic serial number (ESN). Examples of elements or components that may be identified by such addresses or identifiers may include media processing systems, media management systems, personal computers, media or content providers, media exchange software platforms and media peripherals.

FIG. 1B is a diagram illustrating an embodiment of a channel view or channel guide 100 supporting a mixed broadcast and personal media channel in a media exchange network, in accordance with various aspects of the present invention. A media exchange network may be a communication network that, among other things, may facilitate exchange of personal media channels between users of the network, in accordance with various embodiments of the present invention.

The channel view 100 may be a television (TV) channel guide type user interface that may be displayed to a user in order to support the storing of media in media channels using a remote control 110. The television (TV) channel guide user interface may be displayed on a TV screen, PC monitor 109, media peripheral display or other display device. The channel view 100 may comprise a table of media channels 101 and various media program content tied to or associated with a schedule 111.

The various media program content of the channel view 100 may comprise personal media channels 102, friends' and family's media channels 103, and third (3^{rd}) party commercial broadcast channels 104. For example, a personal media channel 102 may comprise a “Kid's Sports” channel 114 that may have previously been created by a user. The personal media channel 102 may comprise a “Son's Soccer Game” 105 that is scheduled to be viewed on Tuesday of the current week, and a “Daughter's Basketball Game” 106 that is scheduled to be viewed on Wednesday of the current week. The third (3^{rd}) party commercial broadcast channels 104 may comprise a first third (3^{rd}) party commercial broadcast channel and a second third (3^{rd}) party commercial broadcast channel. The first third (3^{rd}) party commercial broadcast channel may be, for example, “FOX” 112 and a second third (3^{rd}) party commercial broadcast channel may be, for example, “NBC” 113. The first third (3^{rd}) party commercial broadcast channel “FOX” 112 may comprise a “Program A” 107 that is to be broadcast by a first third (3^{rd}) party commercial broadcaster on Monday of the current week. In a somewhat similar manner, the second third (3^{rd}) party commercial broadcast channel, “NBC” 113, may comprise a “Program B” 108 that is to be broadcast by a second third (3^{rd}) party commercial broadcaster on Tuesday of the current week.

In operation, in instances where a user is not available during, for example, Monday through Friday of the current week to view the scheduled program content such as 105, 106, 107, and 108, then the user may store mixed media program content in a new media channel. In this case, the mixed media program content may comprise, for example, commercial broadcaster program content and personal media program content. The storing may be accomplished by selecting the mixed media program content from the channel view and pushing or otherwise communicating the mixed media content to the new media channel, in accordance with an embodiment of the present invention.

FIG. 1C is a diagram illustrating an updated channel view or channel guide 120 that is an update to the channel view or channel guide 100 of FIG. 1A in accordance with an embodiment of the invention. Referring to FIG. 1C, the updated channel view or channel guide 120 may comprise channels 121 and its corresponding schedule 122. The schedule 122 may comprise a mixed broadcast and personal media channel 123, in accordance with various aspects of the present invention. For example, on Saturday night, the mixed broadcast may comprise program A from commercial broadcaster “FOX” scheduled for viewing at 6 PM and son's soccer from one of the personal media channels 102 scheduled for viewing at 7 PM. Additionally, for Saturday night, the mixed broadcast may also comprise program B from commercial broadcaster “NBC” scheduled for viewing at 8 PM and daughter's basketball from one of the personal media channels 102 scheduled for viewing at 9 PM.

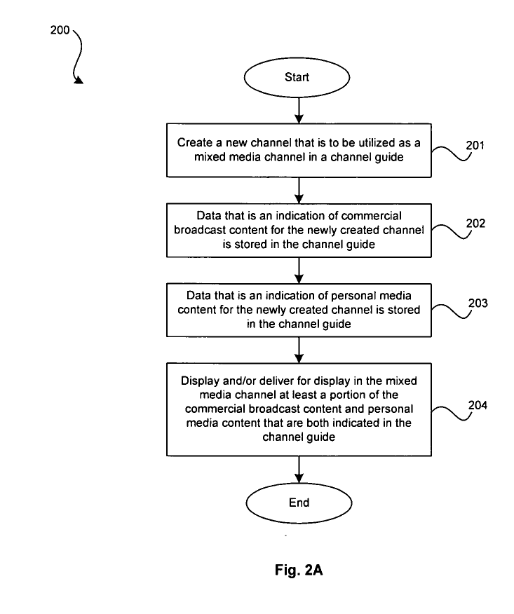

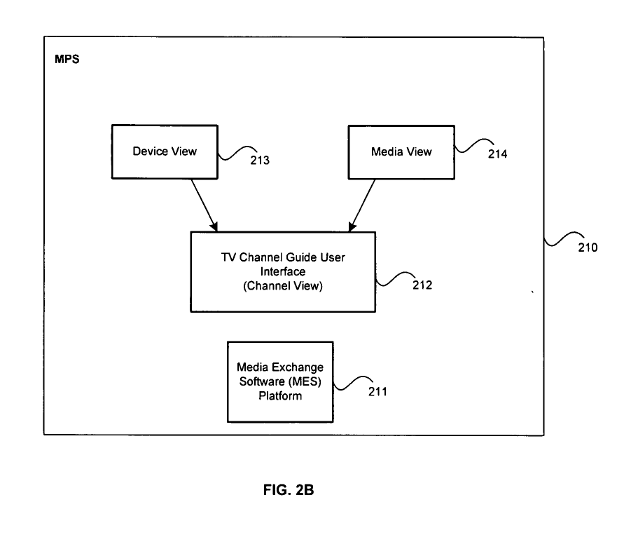

FIG. 2A is a flowchart illustrating an embodiment of a method 200 that may be utilized to store broadcast and personal media in the mixed channel 123 of the updated channel view 120 of FIG. 1C, in accordance with various aspects of the present invention. Referring to FIG. 2A, in step 201, a new channel that is to be utilized as a mixed media channel is created in a channel view or channel guide. In step 202, data that is an indication of commercial broadcast content for the newly created mixed media channel is stored or otherwise placed in the channel guide or channel view. In step 203, data that is an indication of personal media content for the newly created mixed media channel is stored or otherwise placed in the channel guide or channel view. In step 204, at least a portion of the commercial broadcast content and personal media content that are both indicated in the channel guide may be displayed and/or delivered for display in the mixed media channel.

In an illustrative embodiment of the invention, with reference to FIG. 1C, an updated channel view 120 is shown comprising media program channels 121 and a schedule 122. The updated channel view 120 is a newly created channel view when compared to the channel view 100 of FIG. 1B. Although only the channel “Saturday Night” schedule 123 is shown, the invention is not so limited. Accordingly, the newly created channel view 120 may comprise a plurality of other channel schedules, including other dates and times. The newly created media channel “Saturday Night” 123 is a program line-up that a user has created to be viewed on Saturday night of the current week. The newly created media channel, “Saturday Night” 123 comprises the “Program A” 124 from the “FOX” 3^{rd} party commercial broadcaster, the “Son's Soccer Game” 125 from the “Kid's Sports” personal channel 114, the “Program B” 126 from the “NBC” third (3^{rd}) party commercial broadcaster, and the “Daughter's Basketball Game” 127 also from the “Kid's Sports” personal channel 114.

After the new media channel has been created, information related to mixed media content may be stored in the newly created media channel 123. In other words, the newly created media channel 123 may be populated to comprise scheduled mixed media. In this regard, in the newly created media channel “Saturday Night” 123, “Program A” 124 may be stored and scheduled to be viewed at 6 p.m. on Saturday night, and “Son's Soccer Game” 125 may be stored and scheduled to be viewed at 7 p.m. on Saturday night. Additionally, in the newly created media channel 123, “Program B” 126 may be stored and scheduled to be viewed at 8 p.m. on Saturday night, and “Daughter's Basketball Game” 127 may be stored and scheduled to be viewed at 9 p.m. on Saturday night. As a result, if the user is not available to view the program content at its originally scheduled times, then the user may view the program content of the new media channel 123 whenever the user expects to be available. In this case, the user expects to be available at the times scheduled on Saturday night.

The mixed program content 124, 125, 126 and 127 in the updated channel view 120 may be derived from the program content 105, 106, 107 and 108 in the original channel view 100. However, sources other than the original channel view 100 may be utilized as possible media program content sources, in accordance with various embodiments of the present invention. For example, a media peripheral, a local media processing system, a remote media processing system, a server and/or a third party content provider such as a portal may be utilized as possible media content sources.

FIG. 2B is a diagram illustrating several sources of media program content available to the channel view 100 of FIG. 1B in a media processing system (MPS) 210 of the media exchange network of FIG. 1A, in accordance with various aspects of the present invention. The media processing system 210 may be part of a media exchange network that may be used to exchange media content between different users or subscribers on the media exchange network.

The media processing system 210 may comprise a media exchange software (MES) platform 211. The media exchange software platform 211 may provide a channel view 212, a device view 213, and a media view 214. The channel view 212 may also be referred to as the TV channel guide user interface. The media exchange software platform may also be adapted to provide the functionality required to store mixed media into a newly created channel view. For example, the media exchange software platform may facilitate storage of commercial broadcast programs, personal media programs and/or family and friends media channels in the newly created channel view. Although the family and friends media channels 103 are shown separate from the personal media channels 102, the family and friends media channels 103 may also be regarded as a subset of the personal media channels 102.

The device view 213 may comprise a table of devices on the media exchange network versus media content categories. For example, the device view 213 may comprise a 3^{rd} party server, which is the device, storing digital movies, which is the media content category. The media view 214 comprises a table of media content categories on the media exchange network versus specific media content. For example, a media view may comprise a “Music” media content category, which is the media content category, storing songs from several CD's as MP3 files, which is the specific media content. U.S. patent application Ser. No. ______ (Attorney Docket No. 14276US02) filed Sep. 30, 2003 provides an exemplary media view and an exemplary device view, and is incorporated herein by reference in its entirety.

In accordance with an embodiment of the invention, media content may be downloaded via the device view 213 and/or the media view 214 to a channel of the channel view 212, in accordance with various embodiments of the invention. The downloaded media content may comprise both third (3^{rd}) party commercial broadcast program content and personal media content. A combination of different types of media content such as third (3^{rd}) party commercial broadcast program content and personal media content may be referred to as mixed media program content.

In an alternative embodiment of the invention, third (3^{rd}) party commercial broadcast programs may be pushed by a third (3^{rd}) party commercial broadcaster to a user on a media exchange network based on a user profile or a request from the user, in accordance with various embodiments of the present invention. The third (3^{rd}) party commercial broadcaster may charge a fee to the user for such a service. For example, a third (3^{rd}) party commercial broadcast program such as the “Program A” 124 may automatically be pushed by the “FOX” third (3^{rd}) party commercial broadcaster to the “Saturday Night” channel 123 and scheduled at 6 p.m., in accordance with an embodiment of the present invention.

In instances where a program scheduling conflict may occur, program content may be automatically re-scheduled in accordance with various embodiments of the present invention. For example, referring to FIG. 1A, the “Son's Soccer Game” 105 and the “Program B” 108 may both be scheduled to be viewed at 8 p.m. on Tuesday. When the user stores program content in the “Saturday Night” channel 123, the user may direct that each program 105, 106, 107 and 108 be scheduled on Saturday night at the same hour that they were originally scheduled in channel view 100. As a result, a scheduling conflict would exist between the “Son's Soccer Game” 105 and the “Program B” 108 in the new “Saturday Night” channel 123 since they are both scheduled at 8 PM in the original channel view 100.

However, an algorithm such as a conflict check and resolution algorithm in the media exchange software platform 211 may automatically re-schedule the program content within the “Saturday Night” channel 123 in order to eliminate any conflicts. As a result, in this case, the “Son's Soccer Game” 125 may re-scheduled to 7 PM on Saturday night and the “Program B” 126 remains scheduled for 8 PM. on Saturday night as illustrated.

A major challenge is to be able to transfer and share many different types of digital media, data, and services between one device/location and another with ease while being able to index, manage, and store the digital media and data.

For example, it is desirable to be able to distribute and store many types of digital media in a PC and/or television environment in a user-friendly manner without requiring many different types of software applications and/or unique and dedicated interfaces. Any networking issues or other technical issues should be transparent to the users. It is also desirable to take advantage of existing hardware infrastructure, as much as possible, when providing such capability.

In an embodiment of the present invention, a media exchange network is provided that enables many types of digital media, data, and/or services to be stored, indexed, viewed, searched for, pushed from one user to another, and requested by users, using a media guide user interface. The media exchange network also allows a user to construct personal media channels that comprise his personal digital media (e.g., captured digital pictures, digital video, digital audio, etc.), request that third-party media channels be constructed from third-party digital media, and access the media channels pushed to him by other users on the media exchange network.

PC's may be used but are not required to interface to the media exchange network for the purpose of exchanging digital media, data, and services. Instead, set-top-boxes or integrated MPS's (media processing systems) may be used with the media exchange network to perform all of the previously described media exchange functions using a remote control with a television screen.

Current set-top-boxes may be software enhanced to create a MPS that provides full media exchange network interfacing and functionality via a TV screen with a TV guide look-and-feel. PC's may be software enhanced as well and provide the same TV guide look-and-feel. Therefore, the media exchange network supports both PC's and MPS's in a similar manner. Alternatively, a fully integrated MPS may be designed from the ground up, having full MPS capability.

In the case of an MPS configuration, the user takes advantage of his remote control and TV screen to use the media exchange network. In the case of a PC configuration, the user takes advantage of his keyboard and/or mouse to use the media exchange network.

An MPS or enhanced PC is effectively a storage and distribution platform for the exchange of personal and third party digital media, data, and services as well as for bringing the conventional television channels to a user's home. An MPS and/or PC connects to the media exchange network via an existing communication infrastructure which may include cable, DSL, satellite, for example. The connection to the communication infrastructure may be hard-wired or wireless.

The media exchange network allows users to effectively become their own broadcasters from their own homes by creating their own media channels and pushing those media channels to other authorized users on the media exchange network, such as friends and family members.

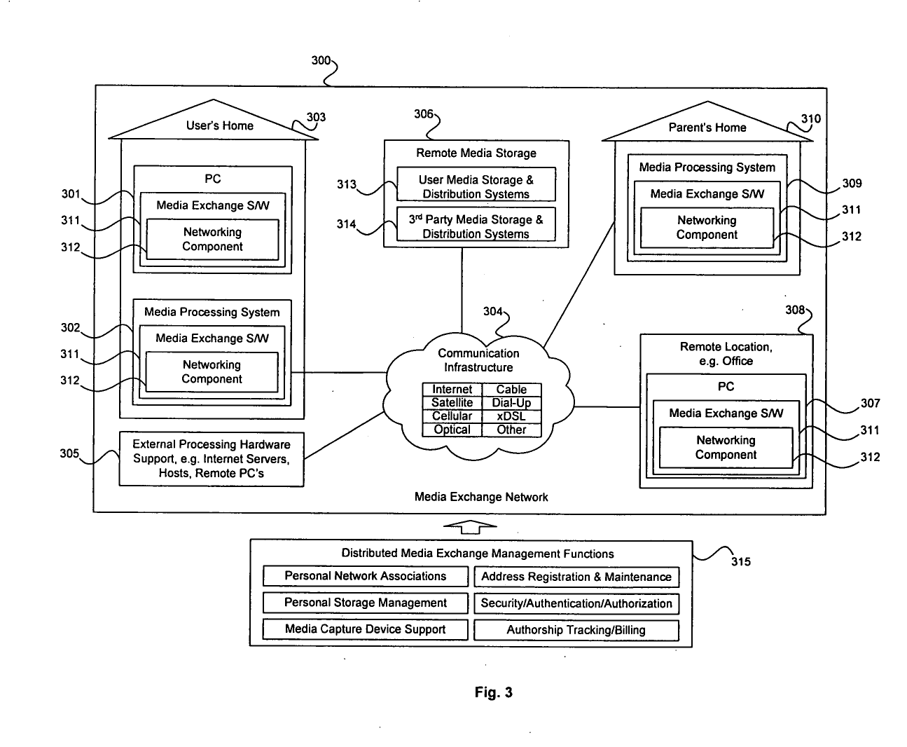

FIG. 3 comprises a media exchange network 300 for exchanging and sharing digital media, data, and services in accordance with an embodiment of the present invention. The media exchange network 300 is a secure, closed network environment that is only accessible to pre-defined users and service providers. The media exchange network of FIG. 3 comprises a first PC 301 and a first media processing system (MPS) 302 at a user's home 303, a communication infrastructure 304, external processing hardware support 305, remote media storage 306, a second PC 307 at a remote location 308 such as an office, and a second MPS 309 at a parent's home 310.

The PC's 301 and 307 and the MPS's 302 and 309 each include a media exchange software (MES) platform 311 and a networking component 312 for connectivity. The MES platform 311 provides multiple capabilities including media “push” capability, media “access” capability, media channel construction/selection, image sequence selection, text and voice overlay, channel and program naming, inter-home routing selection, authorship and media rights management, shared inter-home media experience, billing service, and an integrated media guide interface providing a TV channel guide look-and-feel.

The external processing hardware support 305 comprises at least one server such as a centralized internet server, a peer-to-peer server, or cable head end. The server may alternatively be distributed over various hosts or remote PC's. The MES platform 311 may also reside on the external processing hardware support server 305. The remote media storage 306 may comprise user media storage and distribution systems 313 and/or third party media storage and distribution systems 314.

The communication infrastructure 304 may comprise at least one of internet infrastructure, satellite infrastructure, cable infrastructure, dial-up infrastructure, cellular infrastructure, xDSL infrastructure, optical infrastructure, or some other infrastructure. The communication infrastructure 304 links the user's home 303, parent's home 310, remote media storage 306, and remote location office 308 to each other (i.e., the communication infrastructure 304 links all users and service providers of the media exchange network 300).

The various functions 315 of the media exchange network 300 comprise generating personal network associations, personal storage management, media capture device support, security/authentication/authorization support, authorship tracking and billing and address registration and maintenance. These media exchange management functions 315 may be distributed over various parts of the media exchange network 300. For example, the personal network associations and personal storage management functions may be integrated in the PC 301 at the user's home 303.

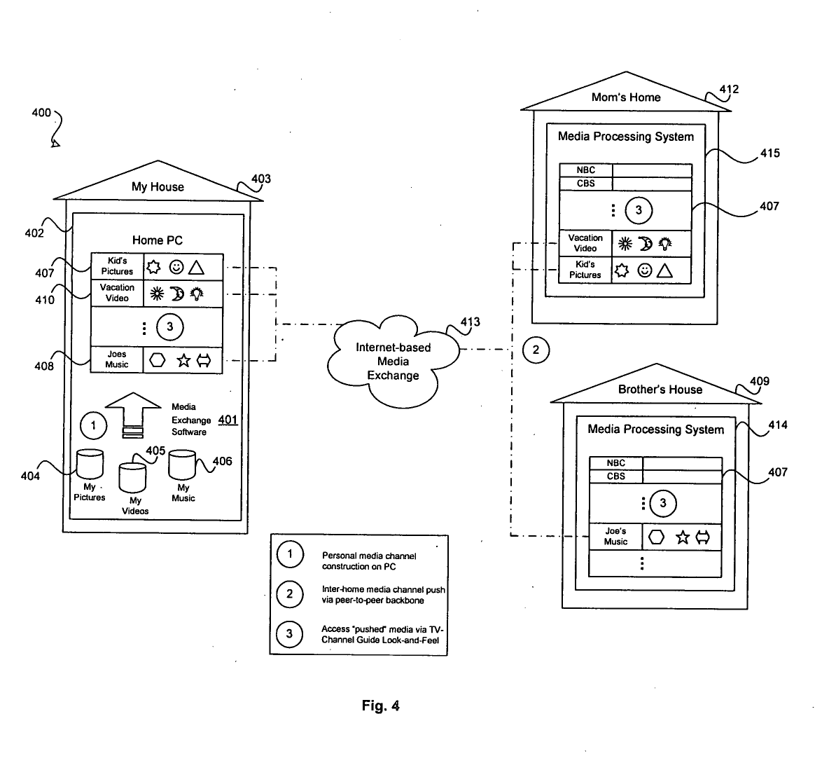

FIG. 4 illustrates an example of personal media exchange over a media exchange network 400 in accordance with an embodiment of the present invention. In step 1, the media exchange software (MES) platform 401 is used to construct personal media channels on a PC 402 by a user at “my house” 403. For example, with various media stored on the PC 402 such as digital pictures 404, videos 405, and music 406, the MES platform 401 allows the digital media to be organized by a user into several channels having a media guide user interface 407 on the PC 402.

In step 2, the user at “my house” 403 pushes a media channel 408 (e.g., “Joe's Music”) to “brother's house” 409 and pushes two media channels 410 and 411 (e.g., “Vacation Video” and “Kid's Pictures”) to “Mom's house” 412 via a peer-to-peer server 413 over the internet-based media exchange network 400. “Brother's house” 409 includes a first MPS 414 connected to the media exchange network 400. “Mom's house” 412 includes a second MPS 415 connected to the media exchange network 400. The MPS's 414 and 415 also provide a media guide user interface 407.

In step 3, brother and/or Mom access the pushed media channels via their respective media processing systems (MPS's) 414 and 415 using their respective MPS TV screens and remote controls.

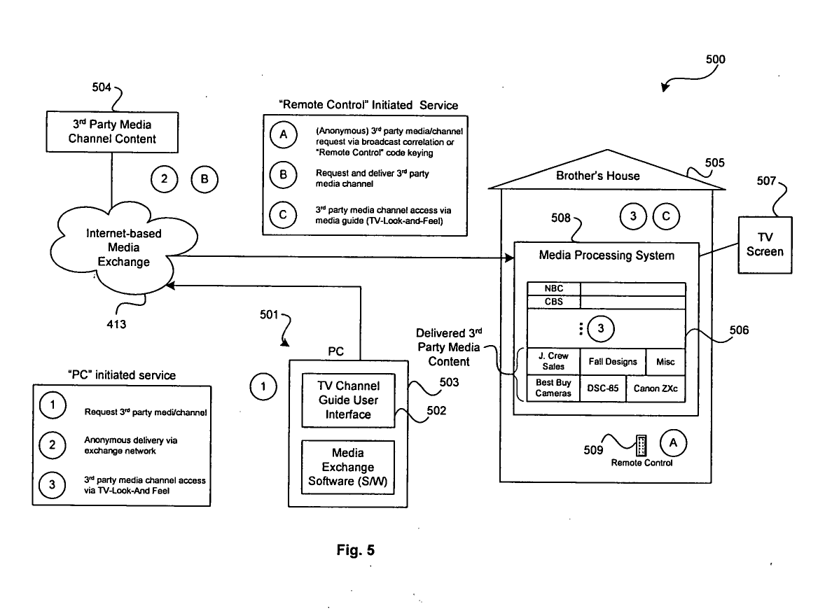

FIG. 5 illustrates an example of third-party media exchange over a media exchange network 500 in accordance with an embodiment of the present invention. In step 1, a PC-initiated third-party request is made by a first party 501 via an internet-based media exchange network 500 using a media guide user interface 502 on a PC 503. In step 2, an anonymous delivery of the requested third-party channel 504 is made to a second party 505 via the internet-based media exchange network 500. In step 3, the second party 505 accesses the third-party channel 504 using a media guide user interface 506 on a TV screen 507 that is integrated into an MPS 508.

Similarly, in step A, an MPS-initiated third-party request is made by a second party 505 via an internet-based media exchange network 500 using a media guide user interface 506 on a TV screen 507 using a remote control 509. The second party 505 may key in a code, using his remote control 509, that is correlated to a commercial or some other third party broadcast media. In step B, an anonymous delivery of the requested third-party channel 504 is made to a first party 501 via the internet-based media exchange network 500. In step C, the first party 501 accesses the third-party channel 504 using a media guide user interface 502 on a PC 503.

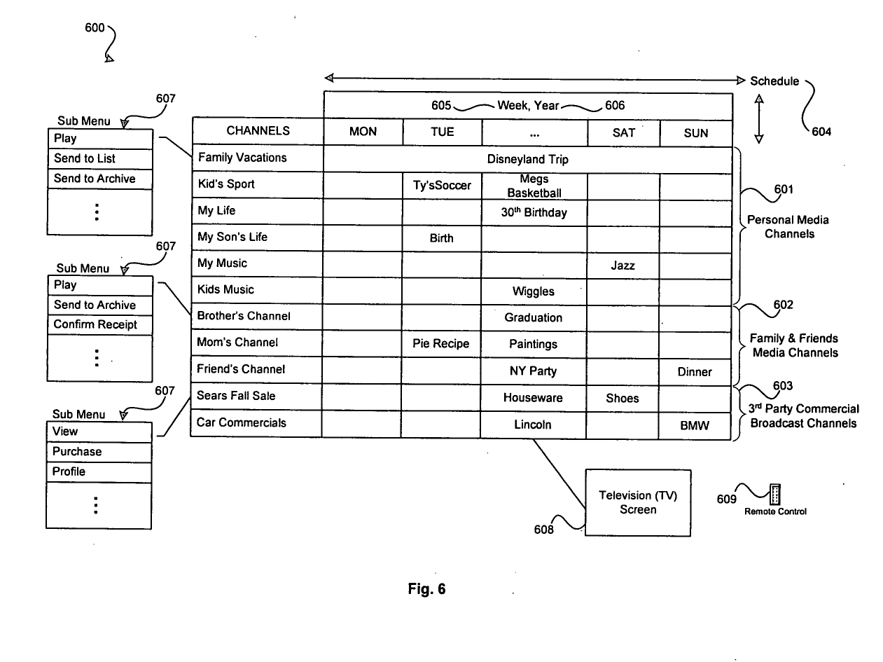

FIG. 6 illustrates a media guide user interface 600 in accordance with an embodiment of the present invention. The media guide user interface 600 may be displayed on a TV screen 608 and controlled by a remote control device 609. Also, the media guide user interface 600 may be displayed on a PC monitor and controlled by a keyboard or mouse.

The media guide user interface 600 may be configured not only for conventional TV channels but also for personal media channels 601 that are constructed by a user of a media exchange network, friend's and family's media channels 602 constructed by friends and family, and third party channels 603 that are constructed by third parties either upon request by a user of a media exchange network or based on a profile of a user.

The personal media channels 601 may include, for example, a “family vacations channel”, a “kid's sports channel”, a “my life channel”, a “son's life channel”, a “my music channel”, and a “kid's music channel”. The friends and family media channels 602 may include, for example, a “brother's channel”, a “Mom's channel”, and a “friend's channel”. The third party media channels 603 may include, for example, a “Sears Fall sale channel” and a “car commercials channel”.

Each media channel may correspond to a schedule 604 showing, for example, a week 605 and a year 606. For example, under the “kid's sports channel”, Ty's soccer game could be scheduled to be viewed on Tuesday of the current week 605 and current year 606. For each media channel, a sub-menu 607 allows for selection of certain control and access functions such as “play”, “send to list”, “send to archive”, “confirm receipt”, “view”, “purchase”, and “profile”.

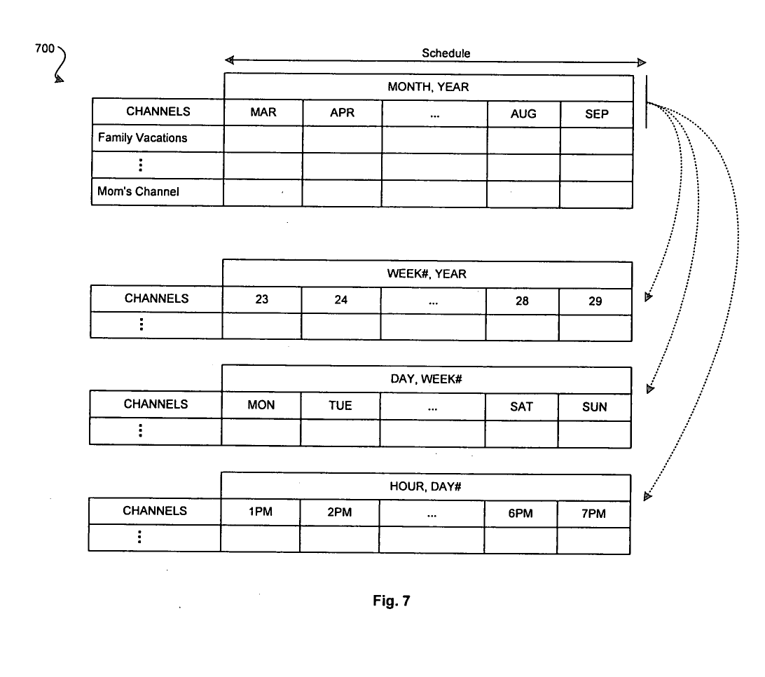

FIG. 7 illustrates possible multiple instantiations of a media guide user interface 700 in accordance with an embodiment of the present invention. The media guide user interface 700 may be viewed with a schedule having formats of, for example, “month, year”, “week#, year”, “day, week#“, or “hour, day”.

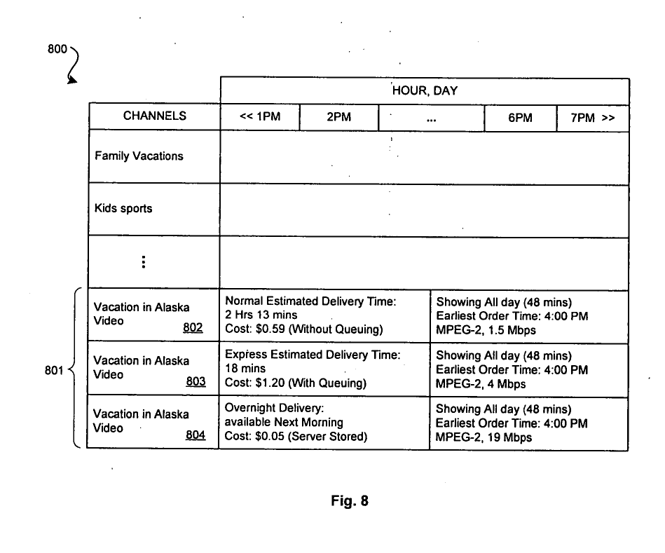

Referring to FIG. 8, a user of a media exchange network may push a media channel (e.g., “Vacation in Alaska Video”) to a friend who is on the same media exchange network. The media guide user interface 800 may give the friend several options 801 for how to accept and download the pushed media in accordance with an embodiment of the present invention.

For example, a first, most expensive option 803 may be “Express Delivery” which would deliver the pushed media to the friend in 18 minutes using queuing and cost $1.20, for example. The pushed media may be stored in a file in an MPEG 2 format that was recorded at a rate of 4 Mbps, for example. Queuing comprises buffering and delivering a previous part of the media and then buffering and delivering a next part of the media. For example, a first six minutes of the “Vacation in Alaska Video” may be buffered and delivered first, then a second six minutes may be buffered and delivered next, and so on until the entire media is delivered.

A second, less expensive option 802 may be “Normal Delivery” which would deliver the pushed media in 2 hours and 13 minutes without queuing and cost $0.59, for example. The pushed media may be stored in a file in an MPEG 2 format that was recorded at a rate of 1.5 Mbps, for example.

A third, least expensive option 804 may be “Overnight Delivery” which would deliver the pushed media by the next morning and cost only $0.05, for example. The pushed media may be stored in a file in an MPEG 2 format that was recorded at a rate of 19 Mbps and stored on a server, for example.

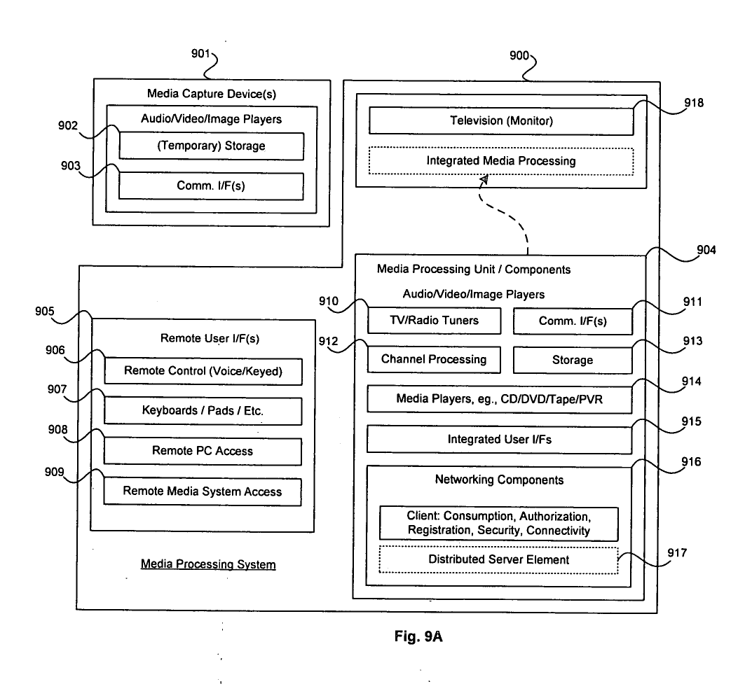

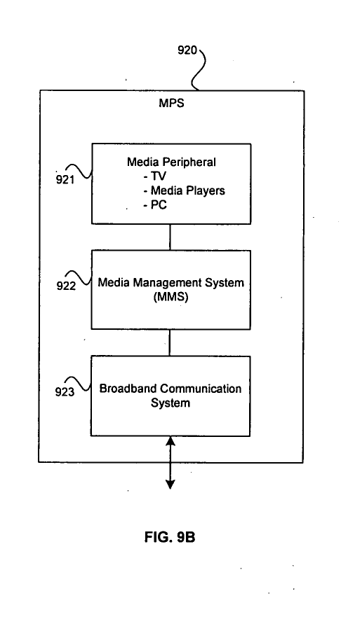

FIG. 9A illustrates the detailed elements of a media processing system (MPS) 900 and media capture devices 901 in accordance with an embodiment of the present invention. The media capture devices 901 may comprise audio, video, and image players, such as digital cameras, digital camcorders, and MP3 players, that each include a temporary storage area 902 and a communication interface 903 such as, for example, a USB interface or a wireless interface. The media capture devices 901 have the capability to interface to an MPS and a PC.

The MPS 900 comprises a media processing unit (MPU) 904, remote user interface(s) 905, and a TV screen 918 to provide integrated media processing capability and indirect user interface capability. The remote user interfaces 905 may comprise a voice or keyed remote control 906, keyboards and pads 907, a remote PC access interface 908, and a remote media system access interface 909 (i.e., providing access from another MPS).

The media processing unit (MPU) 904 comprises TV and radio tuners 910 for image and audio consumption, communications interfaces 911, channel processing 912 (creating, storing, indexing, viewing), storage 913, media players 914 (CD, DVD, Tape, PVR, MP3), an integrated user interface 915 (to provide a TV channel guide look-and-feel), networking components 916 to provide client functions such as consumption (billing), authorization (e.g., using digital certificates and digital ID's), registration, security, and connectivity. In an alternative embodiment of the present invention, the networking components 916 may include a distributed server element 917 that is part of a distributed server.

FIG. 9B illustrates an alternative embodiment of a media processing system (MPS) 920 in accordance with various aspects of the present invention. The MPS 920 is essentially an enhanced set-top-box for viewing and interacting with various user interfaces, media, data, and services that are available on the media exchange network using, for example, a remote control. The MPS 920 comprises a media peripheral 921, a MMS (media management system) 922, and a broadband communication interface 923.

The media peripheral 921 may include a TV (television), a PC (personal computer), and media players (e.g., a CD player, a DVD player, a tape player, and a MP3 player) for video, image, and audio consumption of broadcast and/or personal channels. The broadband communication interface 923 may include internal modems (e.g., a cable modem or DSL modem) or other interface devices in order to communicate with, for example, a cable or satellite headend.

The MMS 922 includes a software platform to provide functionality including media “push” capability, media “access” capability, media channel construction/selection, image sequence selection, text and voice overlay, channel and program naming, inter-home routing selection, authorship and media rights management, shared inter-home media experience, billing service, and a media guide user interface providing an integrated TV channel guide look-and-feel.

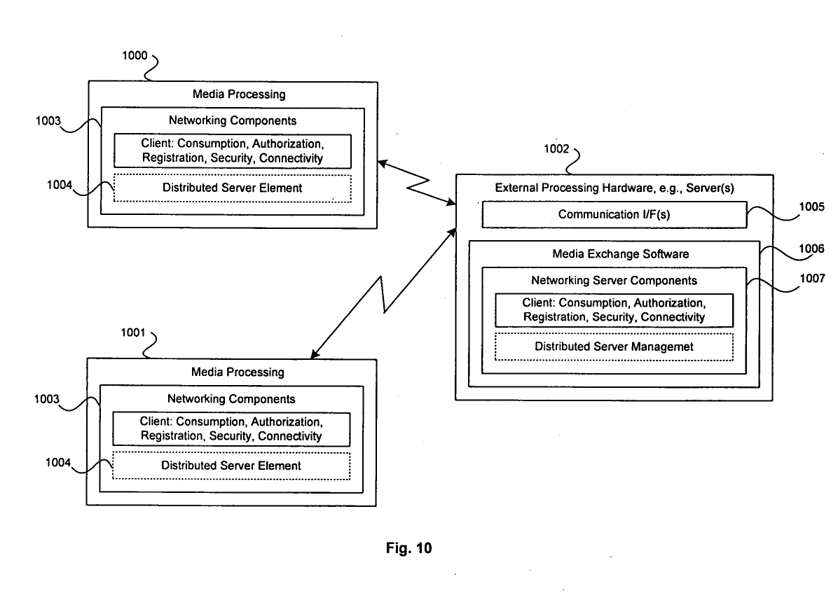

FIG. 10 illustrates connectivity between a PC 1000, an MPS 1001, and external processing hardware 1002 (e.g., a server) in accordance with an embodiment of the present invention. The PC 1000 and MPS 1001 include networking components 1003 to provide client functions such as consumption (billing), authorization, registration, security, and connectivity. Alternatively, the PC 1000 and MPS 1001 may include a distributed server element 1004 that is part of a distributed server.

The PC 1000 and MPS 1001 connect to the external processing hardware 1002 via wired or wireless connections. The external processing hardware 1002 comprises a distributed server or peer-to-peer server. The external processing hardware 1002 also comprises communication interfaces 1005 (e.g., cable interfaces, optical interfaces, etc.) and a media exchange software (MES) platform 1006. The MES platform 1006 in the external processing hardware 1002 allows for communication with the PC 1000 and MPS 1001 which may also use the same MES platform 1006. The external processing hardware 1002 also includes networking server components 1007 to provide the similar client functions such as consumption (billing), authorization, registration, security, and connectivity at the server side.

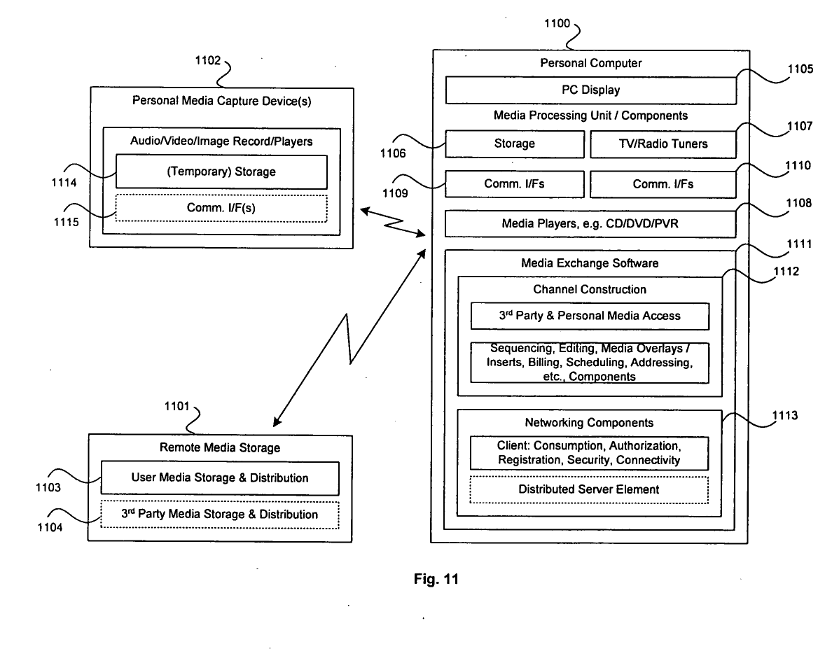

FIG. 11 illustrates connectivity between a PC 1100, remote media storage 1101, and personal media capture devices 1102 when the PC 1100 is used as the primary distributor of digital media such as in the case of PC-to-PC operation, in accordance with an embodiment of the present invention. The personal media capture devices 1102 and remote media storage 1101 connect to the PC 1100 via a wireless or wired connection. The remote media storage 1101 provides user media storage and distribution 1103 as well as third party media storage and distribution 1104. The personal media capture devices 1102 provide temporary storage 1114 and communication interfaces 1115.

Viewing is done using a PC monitor 1105 instead of a television screen. The PC 1100 may include storage 1106, TV/radio tuners 1107 for media consumption, media players 1108, and communication interfaces 1109 and user interfaces 1110 similar to those for the MPS of FIG. 9A. The PC 1100 includes a media exchange software (MES) platform 1111 that provides channel construction capability 1112 and networking capability 1113. The channel construction capability 1112 allows third party and personal media access, sequencing, editing, media overlays and inserts, billing, scheduling, and addressing.

Aspects of the system for providing a customized media channel may comprise at least one processor such as a media processing system 2, that may create a channel view 100 for a new media channel that is a mixed media channel. The channel view 100 may be representative of the media for a mixed media channel. The media processing system 2 may be adapted to populate the channel view 100 for the new media channel with information identifying mixed media content. The mixed media content may comprise at least one personal media content and at least one broadcast media content that may be communicated via the mixed media channel. The mixed media content that is identified in the channel view 100 may be communicated over the mixed media channel. The media processing system 2 may cause the populated channel view 100 to be displayed with the information identifying the mixed media content, for example, in a text format or a graphical user interface (GUI) such as the channel guide user interface of FIG. 1B. In any case, the media processing system 2 may also be adapted to receive the broadcast media content from at least one third (3^{rd}) party broadcaster 14 by the media processing system 2.

The media processing system 2 may store the received broadcast media content and link the stored broadcast media content to a portion of the information utilized to identify the mixed media content. In this regard, the media processing system 2 may store the received broadcast in the storage 15. At least a portion of the personal media content may be identified and/or stored by the media processing system 2. In another aspect of the invention, the identified and/or stored personal media content may be associated or otherwise linked by the media processing system 2 to a portion of the information utilized to identify the mixed media content that corresponds to the personal media content. The media processing system 2 may also be adapted to schedule the personal media content and the broadcast media content within the created channel view 100 for presentation or playback through the mixed media channel. In this regard, the media processing system 2 may assign at least a date and a time within the created channel view 100 for presentation or playback of the personal media content and the broadcast media content. The processor may also be at least one of a media management system processor, a computer processor, a media exchange software platform processor, a media peripheral processor or a combination thereof.

Accordingly, the present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A method for customizing a channel, the method comprising:
creating a channel guide for a new channel that supports communication of media called a media channel;
populating said channel guide for said new media channel with information identifying mixed media content; and
at least one of:
displaying said information identifying said mixed media content within said channel guide; and
communicating said mixed media content via said new media channel.

2. The method according to claim 1, wherein said mixed media content comprises at least one personal media content and at least one broadcast media content.

3. The method according to claim 2, further comprising receiving said at least one broadcast media content from at least one third (3^{rd}) party broadcaster.

4. The method according to claim 3, further comprising storing said received at least one broadcast media content.

5. The method according to claim 4, further comprising linking said stored at least one broadcast media content to a portion of said information identifying said mixed media content which corresponds to said at least one broadcast media content.

6. The method according to claim 2, further comprising storing at least a portion of said at least one personal media content.

7. The method according to claim 2, further comprising identifying said at least said one personal media content.

8. The method according to claim 7, further comprising associating said identified at least one personal media content with a portion of said information identifying said mixed media content which corresponds to said at least one personal media content.

9. The method according to claim 2, further comprising scheduling within said created channel guide, at least one of said at least one personal media content and said at least one broadcast media content for presentation.

10. The method according to claim 9, further comprising assigning at least a date and a time within said created channel guide for said presentation of said at least one personal media content and said at least one broadcast media content.

11. A machine-readable storage having stored thereon, a computer program having at least one code section for customizing a channel, the at least one code section being executable by a machine for causing the machine to perform steps comprising:
creating a channel guide for a new channel that supports communication of media called a media channel;
populating said channel guide for said new media channel with information identifying mixed media content; and
at least one of:
displaying said information identifying said mixed media content within said channel guide; and
communicating said mixed media content via said new media channel.

12. The machine-readable storage according to claim 11, wherein said mixed media content comprises at least one personal media content and at least one broadcast media content.

13. The machine-readable storage according to claim 12, further comprising code for receiving said at least one broadcast media content from at least one third (3^{rd}) party broadcaster.

14. The machine-readable storage according to claim 13, further comprising code for storing said received at least one broadcast media content.

15. The machine-readable storage according to claim 14, further comprising code for linking said stored at least one broadcast media content to a portion of said information identifying said mixed media content which corresponds to said at least one broadcast media content.

16. The machine-readable storage according to claim 12, further comprising code for storing at least a portion of said at least one personal media content.

17. The machine-readable storage according to claim 12, further comprising code for identifying said at least said one personal media content.

18. The machine-readable storage according to claim 17, further comprising code for associating said identified at least one personal media content with a portion of said information identifying said mixed media content which corresponds to said at least one personal media content.

19. The machine-readable storage according to claim 12, further comprising code for scheduling within said created channel guide, at least one of said at least one personal media content and said at least one broadcast media content for presentation.

20. The machine-readable storage according to claim 19, further comprising code for assigning at least a date and a time within said created channel guide for said presentation of said at least one personal media content and said at least one broadcast media content.

21. A system for customizing a channel, the system comprising:
at least one processor that creates a channel guide for a new channel that supports communication of media called a media channel;
said at least one processor populates said channel guide for said new media channel with information identifying mixed media content; and
at least one of:
said at least one processor causing display of said information identifying said mixed media content within said channel guide; and
said at least one processor communicating said mixed media content via said new media channel.

22. The system according to claim 21, wherein said mixed media content comprises at least one personal media content and at least one broadcast media content.

23. The system according to claim 22, wherein said at least one processor receives said at least one broadcast media content from at least one third (3^{rd}) party broadcaster.

24. The system according to claim 23, wherein said at least one processor stores said received at least one broadcast media content.

25. The system according to claim 24, wherein said at least one processor links said stored at least one broadcast media content to a portion of said information identifying said mixed media content which corresponds to said at least one broadcast media content.

26. The system according to claim 22, wherein said at least one processor stores at least a portion of said at least one personal media content.

27. The system according to claim 22, wherein said at least one processor identifies said at least said one personal media content.

28. The system according to claim 27, wherein said at least one processor associates said identified at least one personal media content with a portion of said information identifying said mixed media content which corresponds to said at least one personal media content.

29. The system according to claim 22, wherein said at least one processor schedules within said created channel guide, at least one of said at least one personal media content and said at least one broadcast media content for presentation.

30. The system according to claim 29, wherein said at least one processor assigns at least a date and a time within said created channel guide for said presentation of said at least one personal media content and said at least one broadcast media content.

31. The system according to claim 21, wherein said at least one processor is at least one of a media processing system processor, a media management system processor, a computer processor, media exchange software platform processor and a media peripheral processor.
